(19) United States
(12) Patent Application Publication
(10) Pub. No.: US 2025/0316186 A1
(43) Pub. Date: Oct. 9, 2025

(54) GAME PROGRESS ASSISTANCE SYSTEM, COMPUTER-READABLE NON-TRANSITORY STORAGE MEDIUM HAVING GAME PROGRESS ASSISTANCE PROGRAM STORED THEREIN, GAME PROGRESS ASSISTANCE METHOD, AND ENTERTAINMENT FACILITY

(71) Applicant: NINTENDO CO., LTD., Kyoto (JP)

(72) Inventors: Kazuma KITAMURA, Kyoto (JP); Kei YAMASHITA, Kyoto (JP); Tomoaki YOSHINOBU, Kyoto (JP)

(21) Appl. No.: 19/089,814

(22) Filed: Mar. 25, 2025

(30) Foreign Application Priority Data
Apr. 3, 2024 (JP) 2024-060314

(51) Int. Cl. G09B 19/22; A63F 9/24

(52) U.S. Cl. CPC G09B 19/22; A63F 9/24; A63F 2009/2435; A63F 2009/2463

(57) ABSTRACT

This game progress assistance system provides assistance in a game that progresses using game items placed in a field, and includes: a camera configured to capture an image of the field; a projector configured to project a projection image on the field; and an information processing apparatus. The information processing apparatus acquires object information including positions and kinds of objects corresponding to the game items, based on a captured image captured by the camera. On the basis of the object information, the information processing apparatus determines a combination that satisfies a predetermined first combination condition among combinations of any of first objects located in a first area in the captured image and any of second objects located in a second area in the captured image, and generates the projection image including a first combination indication indicating the combination.

### CROSS REFERENCE TO RELATED APPLICATION

This application claims priority to Japanese Patent Application No. 2024-060314 filed on Apr. 3, 2024, the entire contents of which are incorporated herein by reference.

### FIELD

The present disclosure relates to a system, a program, a method, and an entertainment facility for providing assistance in a game that progresses using game items placed in a field.

### BACKGROUND AND SUMMARY

Conventionally, among board games and card games, there has been known a game in which winning points are added or a specific effect is exerted by combining a plurality of game objects while the game progresses.

### Configuration 1

A configuration 1 is a game progress assistance system for providing assistance in a game that progresses using game items placed in a field, the game progress assistance system including: a camera configured to capture an image of the field; a projector configured to project a projection image on the field; and one or more processors. The one or more processors are configured to: acquire object information including at least position information and category information of an object based on an image of an object corresponding to the game item, included in the captured image; based on the object information, perform a first combination determination to determine a combination that satisfies a predetermined first combination condition among combinations of any of first objects located in a first area in the captured image and any of second objects located in a second area in the captured image; and generate the projection image including a first combination indication indicating the combination that satisfies the first combination condition.

According to the above configuration, an image indicating a candidate of a combination of objects (game items) that satisfies the first combination condition is projected on the field. With this image, a player can visually and intuitively recognize the way of combining game items. Thus, it is possible to assist a player in appropriately proceeding with a game. For example, assistance for smoothly proceeding with a game can be provided to a beginner player who is not familiar with combinations of game items.

### Configuration 2

In a configuration 2 based on the above configuration 1, the processor may be configured to: based on the position information, detect that each of the objects included in the determined combination of the first object and the second object which satisfies the first combination condition is moved to a third area in the captured image; and generate a projection image including a third area indication regarding the third area, when it is detected that the object is moved to the third area.

According to the above configuration, a projection image is generated when a game item is placed in the third area, thereby more appropriately assisting a player in proceeding with a game. For example, it becomes possible to provide assistance in learning ways of combining game items or provide assistance so as to facilitate determination of an action that a player should take next.

### Configuration 3

In a configuration 3 based on the above configuration 1, the game may be a game in which a plurality of players compete, and the first area may be associated with a first player. In the first combination determination, based on the object information, the combination that satisfies the first combination condition among combinations of any of fourth objects located in a fourth area in the captured image which is an area associated with a second player, and any of the second objects located in the second area, may be determined. In the generation of the projection image, the projection image including the following first combination indications may be generated: the first combination indication indicating the combination that satisfies the first combination condition among combinations of any of the first objects located in the first area and any of the second objects located in the second area; and the first combination indication indicating the combination that satisfies the first combination condition among combinations of any of the fourth objects located in the fourth area and any of the second objects located in the second area.

According to the above configuration, in a game in which a plurality of players compete, the first combination indication corresponding to each player can be presented, whereby it becomes possible to more appropriately assist a player in proceeding with a game.

### Configuration 4

In a configuration 4 based on the above configuration 2, the first area and the third area may be associated with a first player. In the first combination determination, based on the object information, the combination that satisfies the first combination condition among combinations of any of fourth objects located in a fourth area in the captured image which is an area associated with a second player, and any of the second objects located in the second area, may be determined. In the detection, based on the position information, it may be detected that each of the objects included in the combination of the second object and the fourth object which satisfies the first combination condition is moved to a fifth area in the captured image which is an area associated with the second player. In the generation of the projection image, the projection image including a fifth area indication regarding the fifth area may be generated, when it is detected that the game item is moved to the fifth area.

According to the above configuration, also in a game in which a plurality of players play and game items are moved between a plurality of areas, appropriate game progress assistance can be provided.

### Configuration 5

In a configuration 5 based on the above configuration 4, the game may be a game in which a plurality of players compete while taking turns. A generation mode may be switchable between: a first generation mode in which the projection image is generated so as to include, in the projection image, a 1P-side combination indication which is the first combination indication indicating the combination that satisfies the first combination condition among combinations of the first objects and the second objects, and so as not to include, in the projection image, a 2P-side combination indication which is the first combination indication indicating the combination that satisfies the first combination condition among combinations of the fourth objects and the second objects; and a second generation mode in which the projection image is generated so as not to include the 1P-side combination indication in the projection image and so as to include the 2P-side combination indication in the projection image. When movement of the object from the second area to the third area is detected, the generation mode may be switched from the first generation mode to the second generation mode, and when movement of the object from the second area to the fifth area is detected, the generation mode may be switched from the second generation mode to the first generation mode.

According to the above configuration, the first combination image corresponding to each player can be projected in accordance with each player's turn. Thus, it is possible to allow each player to easily recognize that the present turn is the player's own turn and easily recognize actions that the player can take, and the like, whereby assistance for game progress can be provided at an appropriate timing.

### Configuration 6

In a configuration 6 based on any one of the above configurations 2 to 5, the captured image may include a second combination condition indication area including an indication of a second combination condition regarding a plurality of kinds of combinations of the objects. A projection image including a second combination indication in which each of third objects which are the objects located in the third area and an indication of the second combination condition associated with the third object among a plurality of indications of the second combination conditions included in the second combination condition indication area, are associated with each other, may be generated.

According to the above configuration, for example, information indicating relevance between an object in the third area and the second combination condition is projected on the field, and thereby can be visually presented to a player. Thus, it is possible to assist the player in recognizing the second combination condition.

### Configuration 7

In a configuration 7 based on the above configuration 6, the processor may be configured to: based on an image of a second condition design indicating the second combination condition and included in a design of the field, acquire position information about the second condition design in the captured image; and based on the position information about the second condition design, acquire position information about the field in the captured image. In the generation of the projection image, the projection image may be generated based on the position information about the field.

According to the above configuration, position information about the field is acquired using the second condition design, and a projection image can be generated based on the position information. Therefore, it is not necessary to individually provide a marker for acquiring the position information.

### Configuration 8

In a configuration 8 based on the above configuration 1 or 2, in the generation of the projection image, a placement position of the first combination indication in the projection image may be determined based on the position information about each of the objects included in the combination that satisfies the first combination condition, to generate the projection image.

According to the above configuration, the positional relationship between game items that satisfy the first combination condition is indicated in a visually emphasized manner. Thus, a player can more intuitively recognize game items that satisfy the first combination condition.

### Configuration 9

In a configuration 9 based on the above configuration 8, the first combination indication may include a line connecting frame indications corresponding to where the objects that satisfy the first combination condition are located at.

### Configuration 10

In a configuration 10 based on the above configuration 8, the game items corresponding to the first objects may be arranged in a line along one predetermined direction in an area on the field corresponding to the first area, and the game items corresponding to the second objects may be arranged in at least two lines along one predetermined direction in an area on the field corresponding to the second area. In the generation of the projection image, the first combination indication may be generated so as to include frame indications respectively enclosing the objects that satisfy the first combination condition, and a line of which a start point is a predetermined position on an outer edge on the second area side of the frame indication enclosing the first object located in the first area in the combination of the objects that satisfies the first combination condition, and an end point is a position in the frame indication enclosing the second object in the combination of the objects that satisfies the first combination condition.

### Configuration 11

In a configuration 11 based on the above configuration 10, the frame indication may be an indication of a rectangular frame. The line may be a straight line of which a start point is a predetermined position on a side line on the second area side of the frame indication and an end point is a center position in the frame indication enclosing the second object.

According to the above configuration, such an image that connects game items that satisfy the first combination condition can be projected. In particular, while game items corresponding to the second objects are placed in two-dimensional arrangement, a certain position, e.g., a center position, in the frame indication is used as one end of the straight line, whereby the interval between the ends of the straight line in such two-dimensional arrangement can be increased to a certain extent, so that it becomes easy to recognize which game items satisfy the first combination condition. Thus, it becomes possible to let a player more intuitively recognize which game items satisfy the first combination condition.

### Configuration 12

In a configuration 12 based on the above configuration 1 or 2, the game items may be card-type game items of which designs on at least one side are different from each other, and in the acquisition of the object information, the category information may be acquired based on the designs of the game items.

According to the above configuration, also in a complicated game in which the designs of game items are different from each other and thus there are a variety of combinations, appropriate game progress assistance can be provided. In particular, in a game using such game items that determination for ways of combinations is performed using only designs of game items without using characters for identifying individual game items, the first combination image as described above is projected, whereby ways of combining game items can be presented in a more understandable manner and assistance for a player to learn ways of combinations can be provided. In addition, by using planar game items like cards, object information can be easily acquired and assistance for game progress can be more appropriately provided.

According to the present disclosure, it is possible to appropriately assist a player in game progress in such a game that progresses through usage of game items placed in a field.

### BRIEF DESCRIPTION OF THE DRAWINGS

FIG. 1 schematically shows a non-limiting example of an entire configuration of a system according to an exemplary embodiment;

FIG. 2 shows a non-limiting example of a design of a play mat;

FIG. 3 shows a non-limiting example of a list of combinations;

FIG. 4 shows a non-limiting example of a hardware configuration of a PC 2;

FIG. 5 shows a non-limiting example of a board situation on the play mat;

FIG. 6 shows a non-limiting example of a first guide image;

FIG. 7 shows a non-limiting example of a board situation on the play mat;

FIG. 8 shows a non-limiting example of a second guide image;

FIG. 9 shows a non-limiting example of a second guide image;

FIG. 10 shows a non-limiting example of a third guide image;

FIG. 11 shows a non-limiting example of second and third guide images;

FIG. 12 shows a non-limiting example of the state of the play mat on which a projection image is projected;

FIG. 13 is a memory map showing a non-limiting example of various data stored in a storage unit 22 of a PC 2;

FIG. 14 shows a non-limiting example of a data structure of game status management data;

FIG. 15 shows a non-limiting example of a detection processing image;

FIG. 16 is a non-limiting example of a flowchart showing the details of a game progress assistance process;

FIG. 17 illustrates a prohibition area;

FIG. 18 illustrates stabilization processing.

### DETAILED DESCRIPTION OF NON-LIMITING EXAMPLE EMBODIMENTS

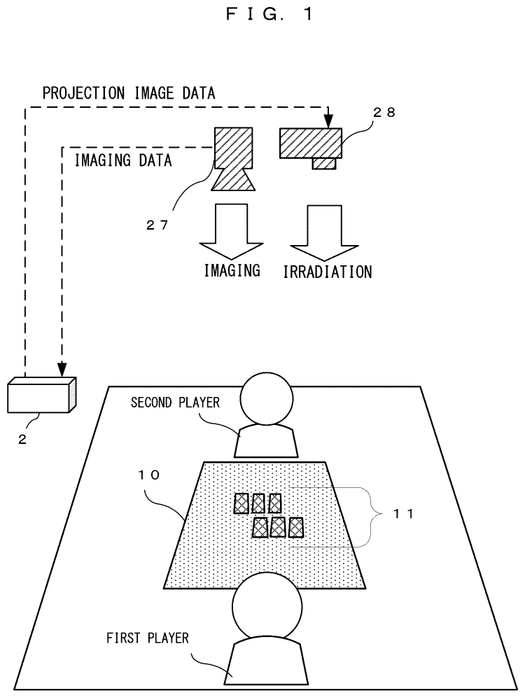

Hereinafter, one exemplary embodiment will be described. It is to be understood that, as used herein, elements and the like written in a singular form with a word “a” or “an” attached before them do not exclude those in the plural form. FIG. 1 is a schematic view showing an entire configuration of a game progress assistance system according to an exemplary embodiment. The game progress assistance system can be provided as an entertainment facility, for example. For example, the game progress assistance system can be provided as one of attractions in a theme park. As another example, the game progress assistance system can be provided as one of teaching materials in a facility aimed at education in school or the like. As another example, the game progress assistance system can be used at home or the like by an individual user. For example, the game progress assistance system is constructed in a predetermined room, and includes elements as shown in FIG. 1. In FIG. 1, a first player hereinafter, 1P), a second player (hereinafter, 2P), a play mat 10, game items 11, a camera 27, a projector (hereinafter, PJ) 28, and an information processing apparatus 2, are shown.

The play mat 10 is used as a game field where the game is performed, and is placed on a floor or a table, for example. The 1P and the 2P sit face-to-face across the play mat 10. On the play mat 10, game items 11 are placed. The game items 11 are physical game elements.

The camera 27 and the PJ 28 are placed on a ceiling of the room, for example. Specifically, the camera 27 is placed at such a position where the camera 27 can capture an image of the play mat 10. For example, the camera 27 is placed approximately at a position directly above a center area of the play mat 10. The PJ 28 is placed at a such a position where an area around the play mat 10 is included in a projection range. For example, the PJ 28 is placed approximately at a position directly above the play mat 10, e.g., a position adjacent to the camera 27.

The information processing apparatus 2 is a personal computer (hereinafter, PC), for example. The PC 2 is connected to the camera 27 and the PJ 28. The connection may be made via a wire or wirelessly. The PC 2 may be placed in the same room as the camera 27 and the PJ 28, or may be placed in a different room. The PC 2 acquires an image captured by the camera 27, and performs processing as described later based on the captured image. On the basis of the processing result, the PC 2 outputs image data to be projected, to the PJ 28. The details of the processing in the PC 2 will be described later.

In the exemplary embodiment, it is assumed that the camera 27, the PJ 28, and the PC 2 are separate devices, as an example. In another exemplary embodiment, some or all of the camera 27, the PJ 28, and the PC 2 may be configured as one information processing apparatus (housed in the same housing), instead of being configured as separate devices.

### Game Items

Next, the game items 11 will be described. In the exemplary embodiment, a case where the game items 11 are card-type items of which at least surfaces on one side have different designs will be described, as an example. Hereinafter, individual cards are referred to as game cards. Specifically, in the exemplary embodiment, “hanafuda” will be described as an example of the game items 11. In the exemplary embodiment, since hanafuda is described as an example, the breakdown of the above cards is as follows: twelve categories (months) are defined and four game cards belong to each category (48 game cards in total). In addition, it is assumed that the designs on one side (front side) of the game cards are different from each other, and the designs on the other side (back side) are the same. In the exemplary embodiment, a play system in which play is performed with game cards placed on the play mat 10 is assumed. In description of the game cards below, the categories are indicated by alphabets and individual game cards belonging to each category are indicated by numbers. For example, four game cards belonging to a category A are indicated as a game card A1, a game card A2, a game card A3, and a game card A4.

### Play Mat

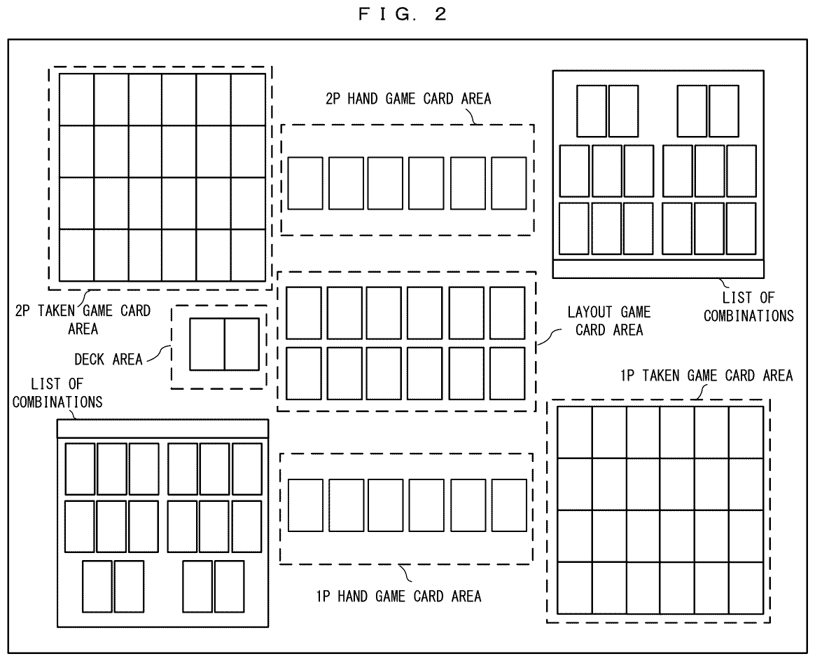

Next, a design printed on the play mat 10 will be described. FIG. 2 shows an example of the play mat 10. On the play mat 10, a plurality of rectangular frame lines (placement frames) indicating guide markings of placement positions for the game cards are printed. The size of the placement frame is almost equal to the size of the game card. In the example shown in FIG. 2, a total of twelve placement frames are printed in an area around the center of the play mat 10. These placement frames are printed in two rows on the upper and lower sides each including six frames. The area (an area enclosed by a dotted line in FIG. 2) around the center of the play mat, including the twelve placement frames, is referred to as a “layout game card area”, below. In the layout game card area, some of the game cards of hanafuda are placed as “layout game cards”.

In the exemplary embodiment, certain areas on the upper and lower sides of the layout game card area are referred to as “hand game card areas”. In the hand game card area, some of the forty-eight game cards of hanafuda are placed as “hand game cards”. In the exemplary embodiment, there are two players, the hand game card area on the lower side in FIG. 2 is defined as a hand game card area for 1P (hereinafter, 1P hand game card area), and the hand game card area on the upper side is defined as a hand game card area for 2P (hereinafter, 2P hand game card area). In the example shown in FIG. 2, the same placement frames as described above are printed as guide markings of placement positions for game cards in the hand game card areas. Specifically, in each hand game card area, six placement frames are printed in a layout of being arranged in a row.

A certain area on the left side of the layout game card area is referred to as a “deck area”. In the deck area, some of the game cards of hanafuda are placed, stacked, as deck game cards. In the deck area, two placement frames are printed.

A certain area on the right side of the 1P hand game card area is referred to as a “1P taken game card area” where a game card acquired by the 1P is to be placed as a “taken game card”. In the 1P taken game card area, twenty-four placement frames are printed (arranged in height 4×width 6). Similarly, a certain area on the left side of the 2P hand game card area is referred to as a “2P taken game card area” where a taken game card is to be placed. Also in the 2P taken game card area, twenty-four placement frames are printed.

In FIG. 2, dotted lines indicating the above areas are shown for convenience of description, and are not actually printed. The design of the placement frame is merely an example. In another exemplary embodiment, a design obtained by removing the frame line of the placement frame and changing the color of the inside may be printed as the placement frame. Alternatively, without the frame line of the placement frame, a design adapted to a system in which only the layout game card area where game cards are placed is demarcated and the game cards in the area are recognized may be used. That is, any design may be used as long as the design serves as a guide marking of a placement position for a game card.

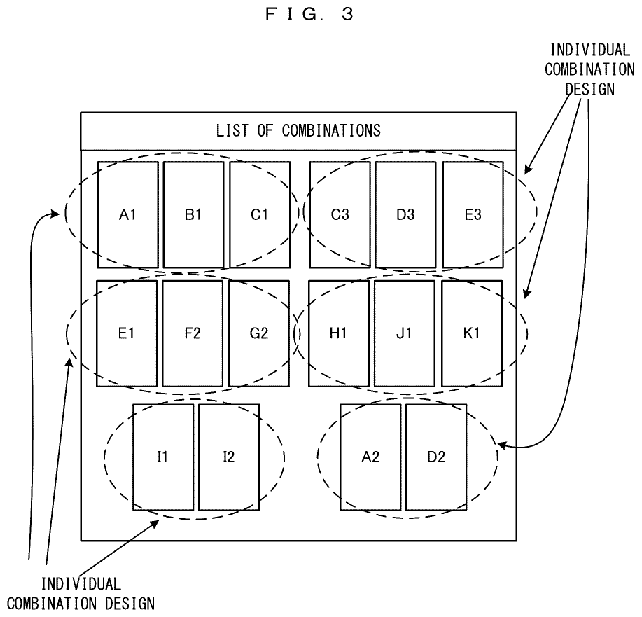

In FIG. 2, “lists of combinations” are printed at the upper right and the lower left on the play mat 10. The list of combinations is a printed design indicating a list of a plurality of kinds of “combinations”. The “combinations” define specific ways of combining a plurality of game cards. In other words, the list of combinations indicates the kinds of game cards defined as components of predetermined combinations. FIG. 3 shows an enlarged view of the list of combinations. In FIG. 3, four “combinations” each constituted of three game cards, and two “combinations” each constituted of two game cards, are shown, and thus a total of six kinds of “combinations” are shown. A design including specific game cards constituting each combination is referred to as an “individual combination design”. For example, the individual combination design at the upper left in FIG. 3 indicates a combination constituted of a combination of three game cards (game card A1, game card B1, and game card C1 which have different designs). In the case of hanafuda, an example of combinations is “inoshikacho”. Although not shown, for each individual combination design, a character string indicating the name of a “combination” may be added at, for example, an upper part of the individual combination design.

The lists of combinations are printed at two locations at the upper right and the lower left on the play mat 10 in FIG. 2 and the printed contents thereof are the same. However, one of the lists is printed in a direction turned from the other one by 180°. The print locations of the lists of combinations are not limited to the upper right and the lower left, and the number thereof is not limited to two. For example, the lists of combinations may be printed at four locations at four corners. As another example, the list of combinations may be printed at one location at the center. The contents described in the lists of combinations present at a plurality of locations and the display manners thereof may be different.

### Hardware Configuration of Information Processing Apparatus

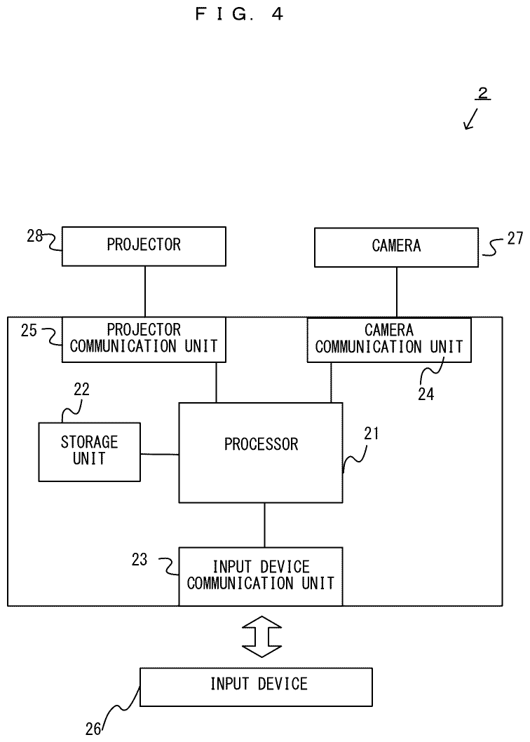

Next, a hardware configuration of the PC 2 will be described. FIG. 4 is a block diagram showing the hardware configuration of the PC 2. The PC 2 includes a processor 21. The processor 21 is an information processing unit for performing various kinds of information processing in the PC 2. The processor 21 executes an information processing program stored in a storage unit 22, to execute various kinds of information processing. The storage unit 22 may be an internal storage medium such as a flash memory or a dynamic random access memory (DRAM), or may be provided by using an external storage medium, for example.

For example, when a “processor of an information processing system” is mentioned, the processor may refer to one or a plurality of processors present in one device such as a body device, or may refer to at least one or all of processors in a case where each of a plurality of devices such as a body device and a server includes one or a plurality of the processors. The same applies to a case of mentioning a “memory of an information processing system” or another configuration.

The PC 2 includes a camera communication unit 24 for communicating with the camera 27. An image (hereinafter, camera image) captured by the camera 27 can be acquired from the camera 27 connected via the camera communication unit 24. Further, the PC 2 includes the projector communication unit 25. The PC 2 outputs, to the PJ 28 connected via the projector communication unit 25, data of a projection image to be projected by the PJ 28.

In addition, the PC 2 includes an input device communication unit 23 for performing wired or wireless communication with various input devices 26 such as a keyboard and a mouse.

### Example of Flow of Assumed Game Play

Next, the outline of a game (hereinafter, hanafuda game) using the hanafuda, assumed in the exemplary embodiment, will be briefly described. In this game, as a preparatory operation for staring the game, twelve layout game cards are placed in the layout game card area. In this case, the placement position of the game cards may be determined using the placement frames as guide markings. However, the game cards may not necessarily be placed so as to be completely fitted to the placement frames. The 1P and the 2P each have six game cards as the hand game cards, which are placed in the 1P hand game card area and the 2P hand game card area, respectively. The other game cards are stacked in a state of facing down and are placed at the left frame in the deck area. When the above arrangement is finished, the game can be started.

In this game, play is performed while the 1P and the 2P are taking turns. First, play is started with a 1P's turn. If a combination of one of the 1P's hand game cards (hereinafter, 1P hand game cards) and one of the layout game cards satisfies a predetermined condition (hereinafter, first combination condition), the 1P can acquire a set of the game cards corresponding to this combination. The 1P places the acquired game card in the 1P taken game card area. The first combination condition is a condition that the game cards belong to the same category (same month). On the other hand, if there is no such combination of game cards that satisfies the first combination condition, the 1P places one of the 1P hand game cards as a layout game card in the layout game card area.

After the above operation for the hand game card, next, the 1P turns over one game card from the deck game cards, and places the turned game card in the right placement frame in the deck area. If this placed game card and one of the layout game cards satisfy the first combination condition, the 1P can acquire the game cards corresponding to this combination.

After the above operation, the 2P has a turn. As with the 1P, first, the 2P determines whether or not there are a 2P hand game card and a layout game card satisfying the first combination condition, and if there are such game cards, the 2P acquires the game cards and places them in the 2P taken game card area. Then, in the same manner as described above, the 2P performs a determination for the first combination condition for the deck game card and any layout game card, and if the condition is satisfied, the 2P acquires them and places them in the 2P taken game card area. Then, the 1P takes a turn again.

The above operations are repeated until the deck game cards run out, and the player who finally has more points wins. Regarding calculation of points, first, with reference to predetermined points set in advance for respective game cards, the points of game cards acquired by each player are summed up. Further, if the taken game cards of each player form a “combination” described above, points associated with the “combination” are also added. In the exemplary embodiment, the way of combining game cards associated with each “combination” is defined as a second combination condition. That is, in a case where taken game cards form one of the “combinations” shown in the list of combinations, it is determined that the second combination condition is satisfied. In other words, the list of combinations is means for presenting information about the second combination condition to the player. The determination for the second combination condition may be performed for each “combination”, or may be performed for a plurality of combinations collectively. For example, in a case where two kinds of “combinations” are completed, it may be determined that the second combination condition is satisfied for each combination at a timing when each “combination” is completed. For example, in a case where a plurality of kinds of combinations are completed, these combinations may be compared with each other and it may be determined that the second combination condition is satisfied for the combination that is most advantageous to the player in turn in game progress. For example, in a case where three or more combinations are completed, these combinations may be compared with each other and it may be determined that the second combination condition is satisfied for the plurality of combinations that satisfy a predetermined condition.

In game progress, when the deck game cards run out, the game is ended. In this case, win and loss are determined by points based on taken game cards at this time.

### Outline of Processing in the Exemplary Embodiment

In a case where the above hanafuda game progresses with the above configuration, in the exemplary embodiment, the following processing is executed. First, the camera 27 captures an image of the play mat. The PC 2 analyzes the camera image, using an object detection AI, and recognizes areas such as the hand game card areas and the layout game card area in the camera image. Further, the PC 2 detects the positions of the game cards and the kinds of the game cards based on the designs of the game cards arranged in each area. Then, based on the detection result, the PC 2 determines whether or not a combination of game cards is valid, i.e., performs a determination for the first combination condition and the second combination condition. Then, based on the determination result, data of an image (hereinafter, guide image) for providing a guide for the way of combining game cards or the like is outputted from the PC 2 to the PJ 28. The details of information processing in the PC 2 will be described later. Then, the guide image is projected from the PJ 28. As a result, the guide image indicating combinations of game cards that can be acquired or the like, for example, is projected on the play mat. Thus, assistance for progress of the game according to the exemplary embodiment is performed. For example, with the guide image projected on the play mat, even a beginner who does not know the rule of hanafuda very well can recognize which game cards should be acquired, whereby the game is enabled to progress smoothly. In addition, it is possible to assist a player to learn combinations.

### Examples of Guide Images

Next, the guide images (means for assistance for game progress) as described above will be exemplified. In the exemplary embodiment, the following guide images are projected.

### Image for Guiding for First Combination

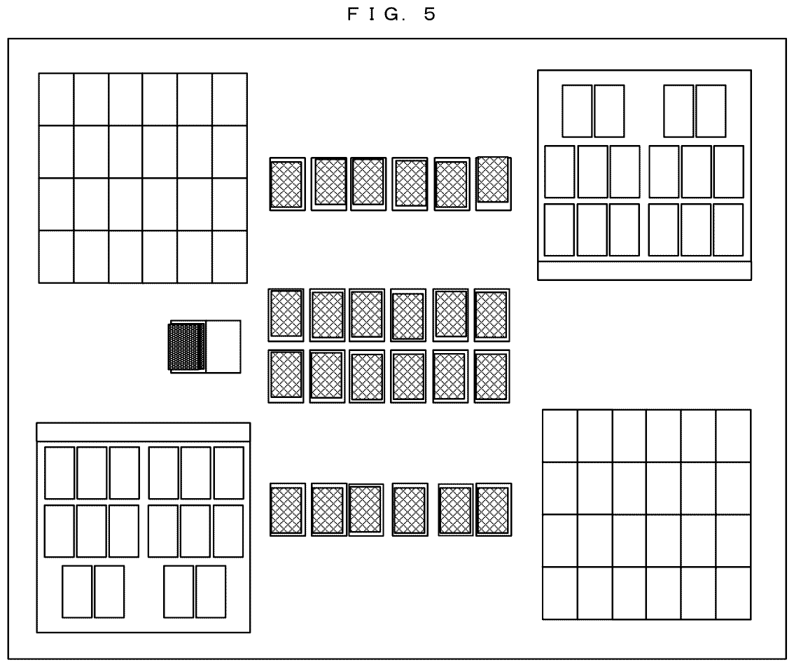

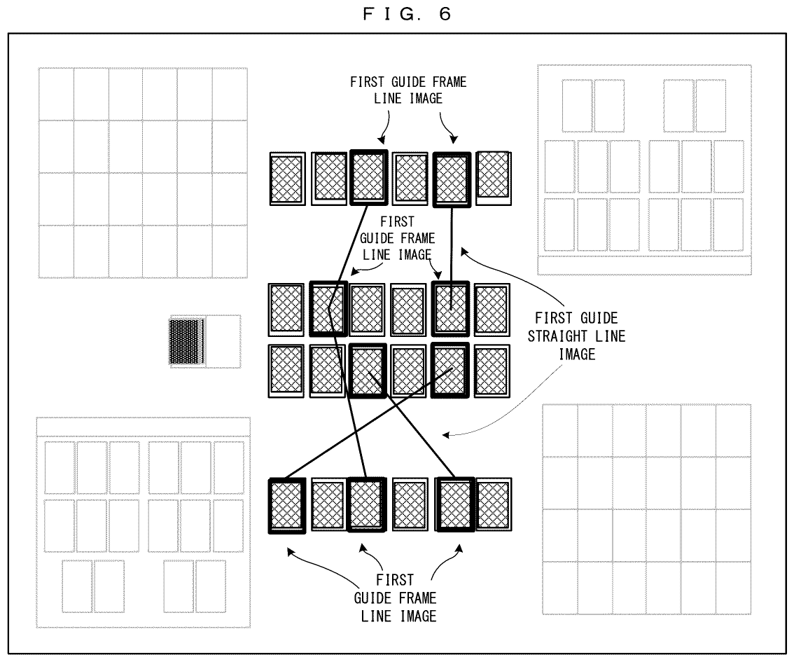

First, a guide image (hereinafter, referred to as a first guide image) for providing a guide for game cards that satisfy the first combination condition, is projected. That is, the first guide image is a guide image indicating candidates of combinations of game cards that can be acquired from the hand game cards and the layout game cards. FIG. 5 shows a board situation on the play mat 10 at a predetermined time. FIG. 6 shows an example of the first guide image projected on the board situation shown in FIG. 5. In FIG. 6, parts on the play mat that are not directly related to projection of the first guide image are shown by light lines, for the purpose of facilitating description.

In FIG. 6, as the first guide image, a frame line image (hereinafter, first guide frame line image) having a rectangular shape and a straight line image (hereinafter, first guide straight line image) connecting predetermined two frame lines, are shown. The first guide frame line image is an image for highlighting a predetermined game card in the 1P hand game card area, the 2P hand game card area, and the layout game card area. For example, the frame line image is a frame line having such a size that encloses the outer frame of the game card. The color of the frame line may be any color, but here, a case where the frame line is white is described as an example. The first guide frame line image provides visual effects of illuminating the periphery of a predetermined game card.

In FIG. 6, the first guide straight line image is an image for indicating a combination of game cards that satisfies the first combination condition, to each of the 1P and the 2P. The first guide straight line image connects game cards that satisfy the first combination condition by a straight line, to indicate the relationship therebetween. In a case where one layout game card satisfies the first combination condition with both of one of the 1P hand game cards and one of the 2P hand game cards, two straight line images connecting the layout game card and each of the 1P hand game card and the 2P hand game card that satisfy the first combination condition, are projected (see, for example, the first game card as counted rightward from the upper left among the layout game cards in FIG. 6). The first guide straight line image may be displayed as such an animation that a straight line moves from the hand game card to the layout game card so as to connect them, for example. An animation in which an arrow moves instead of a straight line may be employed.

By the first guide image projected as described above, it is possible to show a state in which a predetermined game card in the hand game card area of each player and a predetermined game card in the layout game card area are highlighted on the play mat. Further, by the first guide straight line image, it is possible to let each player visually recognize a combination of game cards that satisfies the first combination condition. In the example shown in FIG. 6, the 1P can recognize that three of the 1P hand game cards can be acquired in combination with the layout game cards. In addition, the 2P can recognize that two of the 2P hand game cards can be acquired in combination with the layout game cards. Thus, even a beginner who has not learned the kinds of game cards can visually and intuitively recognize which game cards constitute a combination of game cards that can be acquired. As a result, time for the player to contemplate how to take game cards, and the like, can be reduced, so that the game is expected to progress smoothly.

In the exemplary embodiment, control is performed so that the first guide image as described above is projected at all times irrespective of the turns of the players. In other words, control is performed so that processing in which the placement state of the game cards on the play mat 10 is recognized and the first guide image (and second and third guide images described later) according to the placement state is simply projected, is repeated at predetermined intervals (e.g., 30 fps). In this regard, projection of the first guide image for the 1P and projection of the first guide image for the 2P may be switched in accordance with the turns of the players. For example, in the 1P's turn, control may be performed in a first projection mode in which the first guide image for the 1P hand game card area and the layout game card area is projected but the first guide image for the 2P is not projected. On the other hand, in the 2P's turn, conversely, control may be performed in a second projection mode in which the first guide image for the 1P is not projected and the first guide image for the 2P is projected. A method for determining that a turn is changed may be any method. For example, control may be performed so that the projection mode is switched at a timing when it is detected that game cards satisfying the first combination condition are moved from the layout game card area into the taken game card area for each player. For example, at a timing when it is detected that game cards are moved from the layout game card area to the 1P taken game card area, it may be determined that a turn is transferred to the 2P, whereby the projection mode may be switched from the first projection mode to the second projection mode. In addition, at a timing when it is detected that game cards are moved from the layout game card area to the 2P taken game card area, it may be determined that a turn is transferred to the 1P, whereby the projection mode may be switched from the second projection mode to the first projection mode.

Here, supplementary explanation will be given regarding the positions of both ends of the first guide straight line image. In the example shown in FIG. 6, one end (referred to as a start point) of the first guide straight line image is present at a position in contact with the upper side of the frame line image in the hand game card area for the 1P or the 2P. Meanwhile, the other end (referred to as an end point) is present at a position at the center of the frame line image in the layout game card area. Thus, such a visual effect that centers of game cards are pointed out while the end points have certain intervals therebetween can be provided. In the exemplary embodiment, it is assumed that the hand game cards are arranged in a row and the layout game cards are arranged in two rows on the upper and lower sides. In the case of assuming such two-dimensional arrangement, using the centers of the frame line image for the layout game cards as the end points of straight lines as described above makes it possible to show which game cards can be acquired among game cards arranged two-dimensionally in the layout game card area, to the player, in a more understandable manner.

In another exemplary embodiment, in a case where the processing in the exemplary embodiment is applied to a game other than hanafuda, both ends of the straight line image may be set such that the straight line connects sides of the frame line images or connects the centers of the frame line images.

### Image for Guiding for Second Combination Condition

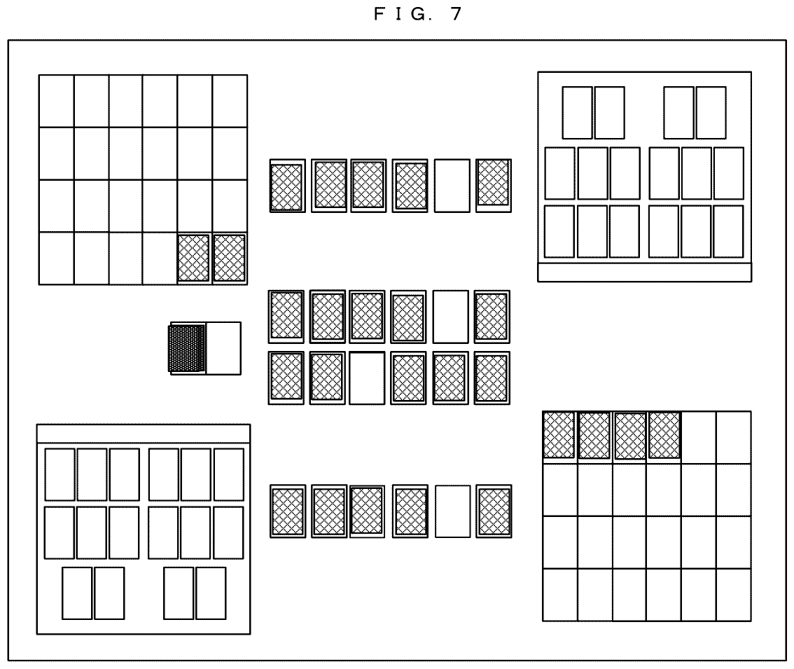

Next, a guide image (hereinafter, second guide image) for providing a guide for the second combination condition will be described. The second guide image is an image for providing a guide for the “combinations” printed on the list of combinations. Before description of the second guide image, first, it is assumed that the players each take one turn from the board situation shown in FIG. 5 and thus a board situation as shown in FIG. 7 appears. Specifically, from the board situation shown in FIG. 5, the 1P takes two layout game cards, one 1P hand game card, and one deck game card, and places these four game cards as taken game cards. The 2P places only one layout game card and one 2P hand game card in the taken game card area, and draws one deck game card, which is added to the layout game cards.

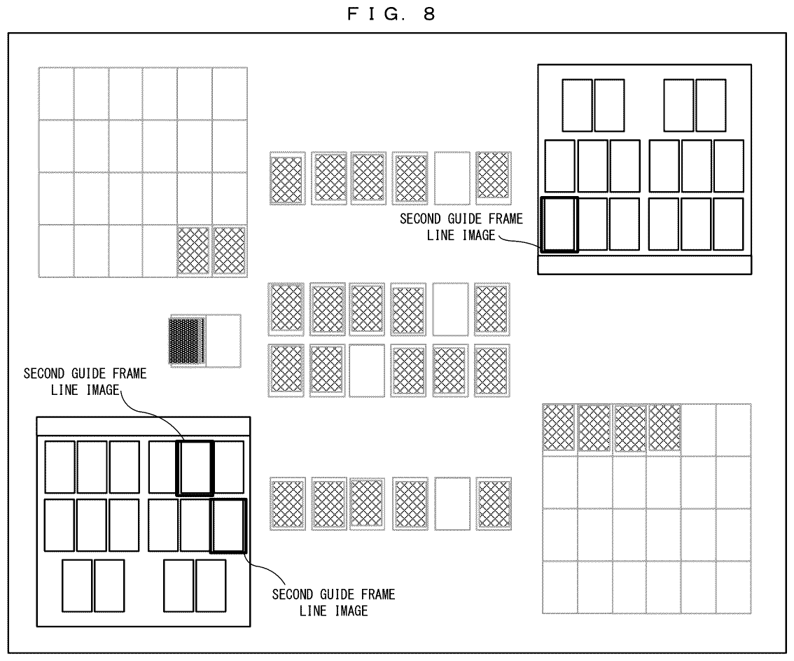

FIG. 8 shows an example of the second guide image projected in the board situation shown in FIG. 7. In FIG. 8, for facilitating the description, parts on the play mat that are not directly relevant to projection of the second guide image are shown by light lines. The second guide image includes a frame line image (hereinafter, a second guide frame line image) for highlighting an image (individual combination design) of any of the “combinations” printed on the list of combinations or a printed part of any of game cards constituting the “combination”. Specifically, in a case where a game card constituting a predetermined combination is present among game cards in the taken game card area, the second guide image is an image for providing a guide for indicating that there is a “combination” having a possibility of being completed and specifically indicating what the “combination” is like, for example. For example, in a case where a game card constituting a predetermined combination is present in the taken game card area, the second guide frame line image is used for highlighting a printed part of one of game cards in the individual combination design corresponding to the above game card constituting the predetermined combination. FIG. 8 shows an example of the second guide frame line image in such a case. In addition, when any of the “combinations” is completed among the taken game cards, the second guide frame line image to highlight the entirety of the individual combination design corresponding to the completed combination is projected.

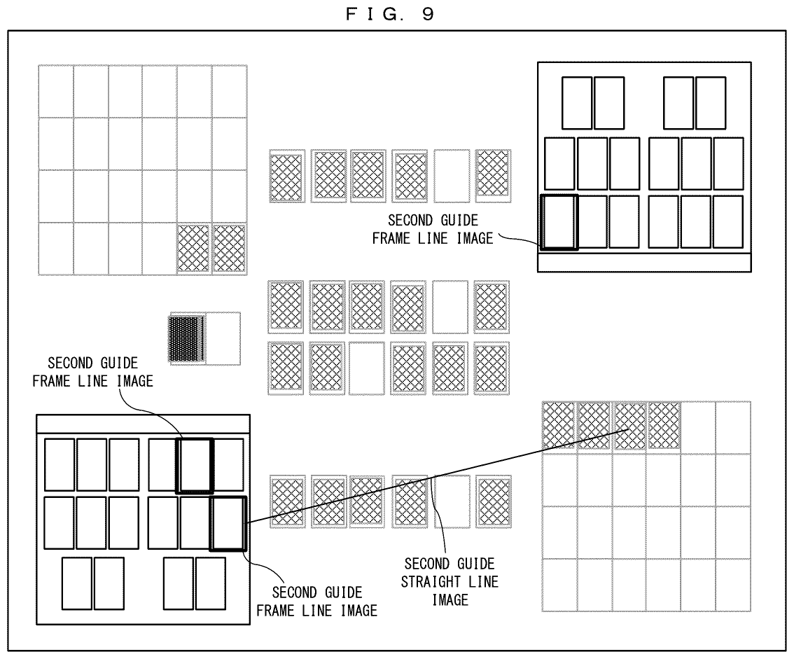

In addition, in a case where, when a game card is placed in the taken game card area, the placed game card has the same design as a game card constituting any of the “combinations”, a straight line image (hereinafter, a second guide straight line image) for indicating the “combination” is temporarily projected. For example, as shown in FIG. 9, the second guide image including the second guide frame line image for highlighting the game card constituting the “combination” on the list of combinations and the second guide straight line image extending from a side of the second guide frame line image to the position where the taken game card is placed, is projected for a predetermined period, for example. Thus, in a case where a newly acquired taken game card is a part of any “combination”, the player can easily visually recognize that there is a possibility that a predetermined “combination” can be completed. Since the list of combinations is printed on the play mat in advance, the positions where the designs of the game cards constituting the combinations are printed are also known in advance. Therefore, as long as the position of the play mat can be identified in the captured image, the position at which the second guide frame line image is to be projected can be derived without separately performing image recognition processing for the list of combinations.

The positions of both ends of the second guide straight line image may be set such that the straight line has a start point at a position on a side of the second guide frame line image and an end point at the center of the third guide frame line image, for example. The start point position and the end point position may be reversed with each other. The straight line may connect the centers of the frame line images.

### Image for Guiding for Information About Taken Game Card

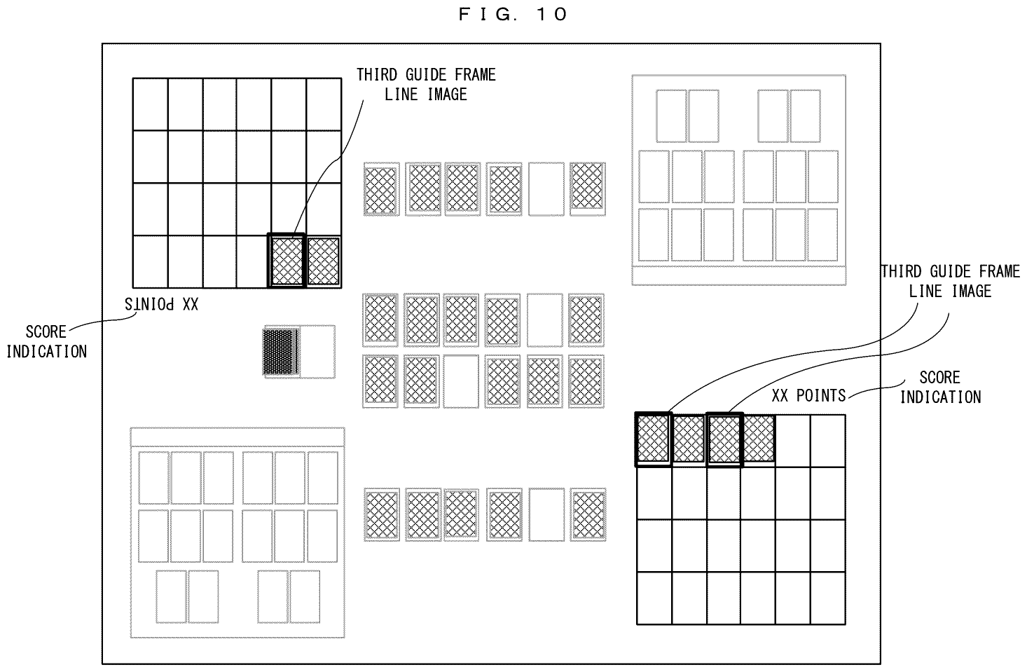

Further, in the exemplary embodiment, a guide image (hereinafter, a third guide image) for providing a guide for information about a taken game card is also projected. FIG. 10 shows an example of the third guide image projected in the board situation shown in FIG. 7. The third guide image includes a score indication indicating points at present, and a frame line image (hereinafter, a third guide frame line image) for highlighting a predetermined game card in the taken game card area. The score indication is projected at a position upward of the taken game card area. In a case where a game card constituting any of the “combinations” defined in the list of combinations is present among the taken game cards, the third guide frame line image highlights the game card. In other words, presentation of the second guide frame line image and the third guide frame line image provides such a visual effect that identical game cards are highlighted. Thus, it is possible to intuitively recognize which combination in the list of combinations is constituted by the game card highlighted by the third guide frame line image.

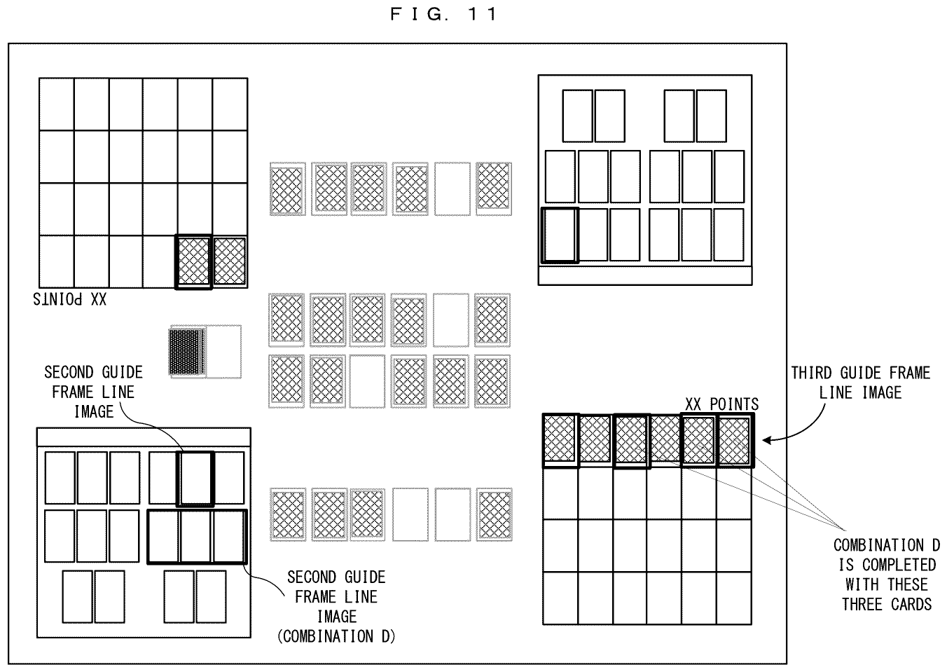

FIG. 11 shows a projection example of the second guide image and the third guide image. In a board situation shown in FIG. 11, it is assumed that, from the board situation shown in FIG. 7, the 1P moves one layout game card and one hand game card to the taken game card area and places one game card from the deck game cards as a layout game card, so that a “combination D” is completed with the 1P taken game cards. In this case, at a part where the “combination D” is printed on the list of combinations, the second guide frame line image covering the entirety of the combination D is projected as the second guide image. In addition, in the taken game card area, score indication and the third guide frame line images for highlighting three game cards constituting the “combination D” are projected as the third guide image. In addition, the second guide frame line image for highlighting a certain game card constituting a “combination B” which has not been completed yet and the third guide frame line image for highlighting the game card in the taken game card area corresponding to the above certain game card, are also projected.

Regarding the second guide image in a case where a combination is completed, the second guide straight line image as shown in FIG. 9 may be displayed for a certain period, and then the projection content may be changed so as to surround the entirety of the completed combination as shown in FIG. 11. When the combination is completed, the projection content of the third guide frame line images may be changed. For example, projection of the third guide frame line images for the completed combination may be canceled in order to discriminate between game cards constituting a completed combination and a game card constituting a combination to be completed in the future.

Projecting the second guide image as described above allows the player to recognize which combination is close to completion or has been completed. In addition, it is possible to assist the player in learning which game cards constitute each kind of combinations. In addition, projecting the third guide image can provide information for assisting the player in considering the strategy of the game or the like.

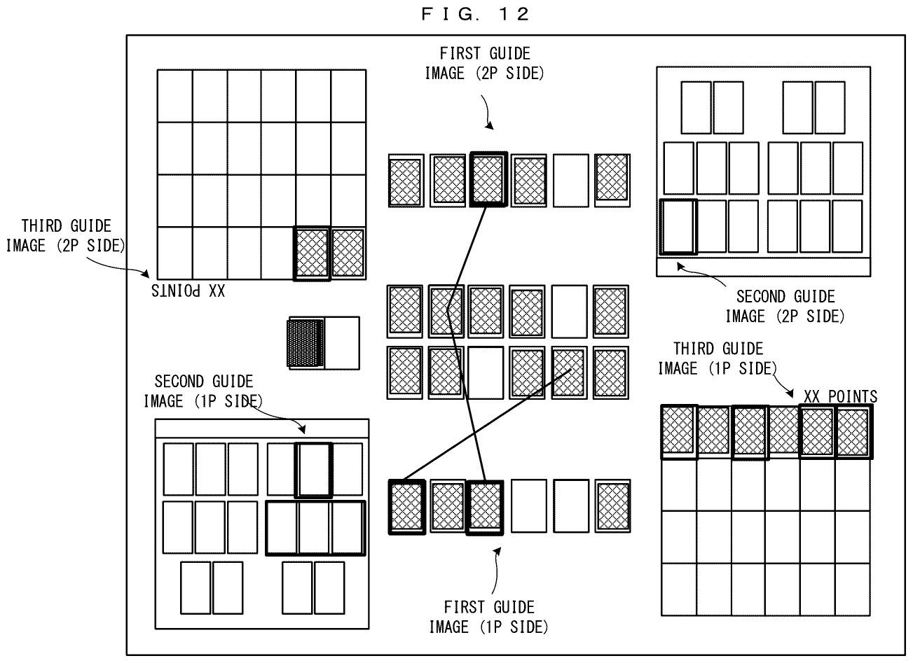

FIG. 12 shows an example of a finally projected guide image including the first to third guide images. Projecting the guide image as shown in FIG. 12 on the play mat 10 can assist the player in smoothly proceeding with the game. For example, the player can immediately recognize candidates of game cards that can be taken, with reference to the first guide image. In addition, with the second guide image and the third guide image, the player can recognize the situation of the taken game cards at present and whether or not there is a combination coming close to completion, and can utilize such image indications for learning combinations of hanafuda and establishing the strategy of the game.

The specific configurations of the respective kinds of guide images described above are merely examples. Without limitation thereto, images having the following contents may be used as guide images.

For example, in a case where there are a plurality of combinations satisfying the first combination condition, guide images are projected for all the combinations in the above example, but guide images may be projected for only some of the combinations. For example, a guide image may be projected for only a combination that provides the highest advantage to the player.

In a case of indicating that there are a plurality of combinations satisfying the first combination condition, the way of indication by a guide image may be different among the combinations. In the above description, all combinations are indicated by straight line images. However, for example, in a case where there are two combinations, one of the combinations may be indicated by a straight line connecting the game cards, and the other one may be indicated by blinking the first guide frame line image. Alternatively, the colors of the first guide frame line images may be made different among the combinations. Only frame line images or only straight line images may be used.

The image content and expression for indicating the first combination are not limited to the image content and expression that use a straight line as described above. For example, a word or an image (other than a straight line) indicating the first combination condition may be displayed. For example, a curve may be used.

Only parts at the game cards that satisfy the first combination condition may be displayed with their color changed. Meanwhile, images may be projected so that parts at game cards other than the game cards that satisfy the first combination condition, i.e., game cards that cannot be acquired, are masked with a predetermined color.

As the first guide image, the coordinates where each game card is placed and numerals (frame numbers, etc.) indicating frames may be included. For example, a character string indicating that “You can take the nth game card and the mth game card” or “You can take a game card for the nth month” may be projected as the first guide image. In the above example, the case where the periphery of a game card that can be acquired is illuminated using the first guide frame line image has been shown. However, such an image that illuminates the entire game card that can be acquired may be projected.

A guide image for imparting a predetermined effect (e.g., a ripple) around each game card may be used.

As another example, such projection that a human cannot sense may be used. For example, slight perturbation or the like may be applied, and this may be acquired by a camera other than the camera 27. Then, a predetermined speech may be outputted from a predetermined position, to provide speech guidance for the first combination condition or the like.

Also for the second guide image and the third guide image, any image content may be used as in the above cases. For example, regarding the second guide image, an image for highlighting the entire area of the list of combinations may be projected, or as described above, each individual combination may be highlighted or each game card constituting the combination may be highlighted. In the case of highlighting each game card constituting the combination, the player can specifically recognize which game card of the combination has been acquired and which is the combination to which the acquired game card belongs. In the case of highlighting each individual combination, the player can recognize which combination is constituted by the acquired game card. In the case of highlighting the entirety of the list of combinations, the player can recognize that any “combination” has been completed, but the player is let to determine which combination has been specifically completed. In any case, it is possible to assist a player who is particularly a beginner in learning “combinations” through actual game play.

In the exemplary embodiment, it is assumed that the list of combinations is printed on the play mat 10 in advance. However, in another exemplary embodiment, the list of combinations may not be printed on the play mat 10, and an image of the list of combinations may be projected as the second guide image. In addition, at this time, the content of the image to be projected as the list of combinations may be changed in accordance with the hand game card status of the player. For example, such an image of the list of combinations that a combination close to completion is displayed in a highlighted state may be projected.

Regarding the third guide image, instead of or in addition to display of points, characters or an image indicating the time at which each game card is placed in the taken game card area may be projected, for example. This is useful for a game in which the time at which the game card is placed is used as a game element, e.g., a case of competing in terms of time. As the third guide image, various kinds of information about taken game cards may be projected. Examples of the information include the total number of taken game cards at present, the number of taken game cards for each category (month), and the number of completed combinations. In a case of application to a game other than hanafuda, for example, an image or the like for providing a guide for an action that the player can take based on a game item placed in an area corresponding to the taken game card area may be projected. Another parameter to be used during a game, e.g., the remaining number of times of actions or lives, may be projected.

### Details of Processing Executed by PC 2

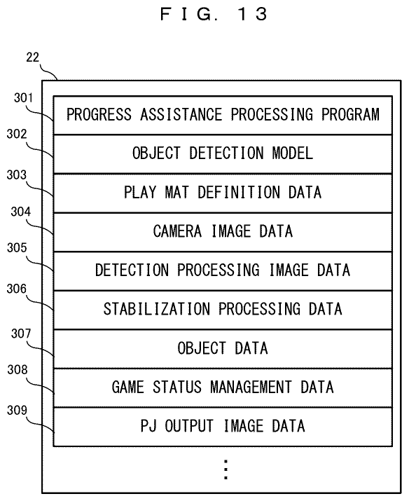

Next, with reference to FIG. 13 to FIG. 18, processing to be executed by the PC 2 for projecting the guide images described above (hereinafter, game progress assistance process) will be described in detail.

### Used Data

First, various data used in the game progress assistance process will be described. FIG. 13 is a memory map showing an example of various data stored in the storage unit 22 of the PC 2. The storage unit 22 stores a progress assistance processing program 301, an object detection model 302, play mat definition data 303, camera image data 304, detection processing image data 305, stabilization processing data 306, object data 307, game status management data 308, PJ output image data 309, and the like.

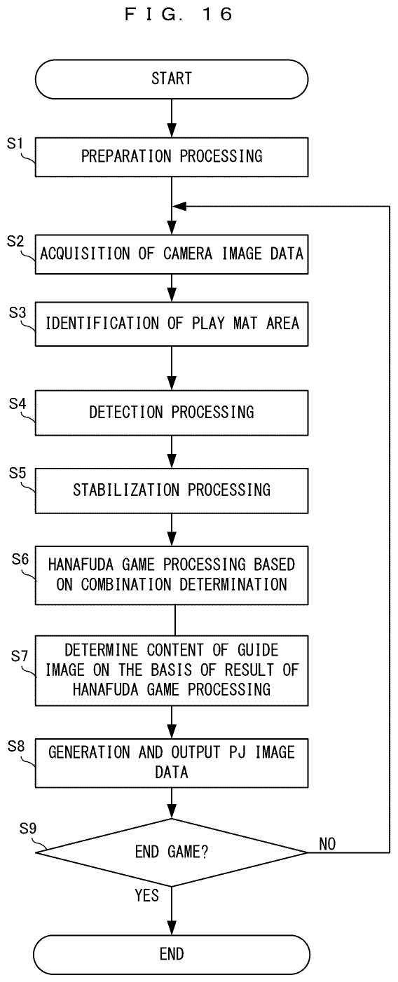

The progress assistance processing program 301 is a program for performing the game progress assistance process as described above. Specifically, the progress assistance processing program 301 is a program for executing a process shown in a flowchart in FIG. 16 described later.

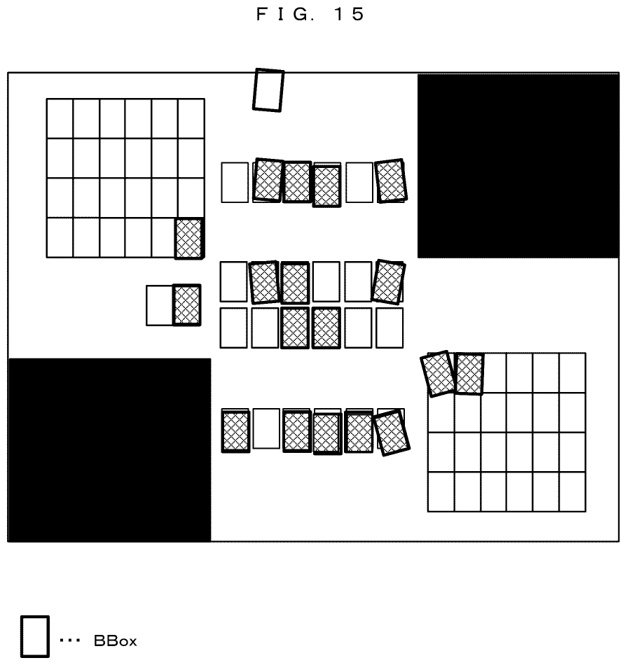

The object detection model 302 is a trained model that has undergone learning about the designs of game cards of hanafuda in advance, and is used for image recognition processing (object detection algorithm) by an object detection AI. In the exemplary embodiment, image data of a detection processing image described later is inputted, whereby detection for hanafuda is performed on the image. As a detection result, one or more bounding boxes (hereinafter, BBox) are outputted. FIG. 15 shows an image of the detection result. The image in FIG. 15 is such an image that a plurality of rectangular frames (BBoxes) are placed on the detection processing image described later. In the exemplary embodiment, basically, as long as detection is not erroneous, one BBox corresponds to one game card placed face-up. In the exemplary embodiment, a game card placed face-down is not a detection target. As a modification, for example, a design of a game card placed face-down may be detected and this detection result may not be reflected as an output of a BBox. Each BBox includes at least information indicating the kind of the game card and the position of the game card in the image.

In the play mat definition data 303, information about the play mat 10 is defined. Specifically, the following information is defined. First, a physical size of the entirety of the play mat 10 is defined. In addition, information specifying positions and ranges to be used as the hand game card areas, the layout game card area, the taken game card areas, and the deck area described above on the play mat 10 is defined. Further, image data indicating the design of the list of combinations and information indicating two printing positions of the list of combinations on the play mat 10, i.e., information specifying areas where the list of combinations is printed, are defined. In addition, information indicating printing positions of the designs of game cards printed on the list of combinations is also defined. In addition, information indicating a “prohibition area” described later, and the like, are defined.

The camera image data 304 is stored data of an image captured by the camera 27.

The detection processing image data 305 is image data obtained by processing the camera image data 304, and is used as an input to the object detection model 302. The details of this processing will be described later.

The stabilization processing data 306 includes various stored data to be used in the stabilization processing described later.

The object data 307 is data of an “object” to be generated based on a BBox which is a detection result by the object detection model 302. This object data is data corresponding to each game card placed on the play mat 10. In hanafuda game processing described later, various game processes such as combination determination for game cards are performed based on the objects. In other words, the object is data obtained by converting each game card which is a physical game item into a form available in game processing. As described later in detail, in the exemplary embodiment, the stabilization processing is performed for the detection result from the object detection model 302. Then, an object is generated based on a detection result (BBox) in which a result of the stabilization processing is reflected, and the object is stored as the object data 307. Basically, one object corresponds to one game card. However, this does not apply to a merged object described later. Each object includes various data to be used in the game processing, e.g., a “detection parameter” described later, in addition to the content based on the data of the BBox.

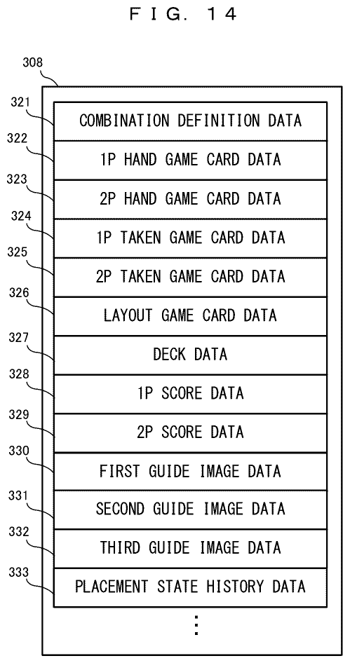

The game status management data 308 includes various data for managing progress of the hanafuda game according to the exemplary embodiment. FIG. 14 shows an example of the data structure of the game status management data 308. The game status management data 308 includes the following data.

First, combination definition data 321 for defining the first combination condition and the second combination condition is included.

In addition, data in which the objects (game cards) are classified into a hand game card, a layout game card, a deck game card, and a taken game card based on position information about the objects, are stored as follows. That is, 1P hand game card data 322 which is data corresponding to each game card in the 1P hand game card area, and 2P hand game card data 323 which is data corresponding to each game card in the 2P hand game card area, are stored. In addition, 1P taken game card data 324 including information corresponding to each taken game card of the 1P and information indicating a combination associated with a taken game card of the 1P, and 2P taken game card data 325 including information corresponding to each taken game card of the 2P and information indicating a combination associated with a taken game card of the 2P, are stored. In addition, layout game data 326 which is data corresponding to a game card placed in the layout game card area, and deck data 327 which is data corresponding to a game card placed in the deck area, are stored.

Further, 1P score data 328 and 2P score data 329 for managing points of the 1P and the 2P are stored.

In addition, first guide image data 330 which is image data of the first guide image, second guide image data 331 which is image data of the second guide image, and third guide image data 332 which is image data of the third guide image, are stored.

Regarding the 1P hand game card data 322, the 2P hand game card data 323, the 1P taken game card data 324, the 2P taken game card data 325, the layout game data 326, and the deck data 327, placement state history data 333 for keeping data obtained in a period from the present to several frames to several tens of frames ago, for example, is stored. That is, the placement state history data 333 is data in which the placement states of the game cards from the present frame to several frames to several tens of frames ago are temporarily stored.

Returning to FIG. 13, the PJ output image data 309 is image data generated based on the first guide image data 330, the second guide image data 331, and the third guide image data 332, and is data of the guide images to be finally projected by the PJ 28. These guide images may be generated as one image data, so as to be placed in one virtual space.

### Details of Processing Executed by Processor 21

Next, the details of the game progress assistance process according to the exemplary embodiment will be described. The flowchart shown below is merely an example of a processing procedure. Therefore, the processing order of steps may be changed as long as the same result is obtained. In addition, values of variables and thresholds used in determination steps are also merely an example, and other values may be employed as necessary.

FIG. 16 is a flowchart showing the details of the game progress assistance process according to the exemplary embodiment. A processing loop of steps S2 to S9 in the flowchart is repeatedly executed in every frame. In the exemplary embodiment, it is assumed that the frame rate is 30 fps.

### Preparation Processing

First, in step S1, the processor 21 executes preparation processing for starting a game. The processor 21 causes the PJ 28 to project a message for instructing a player to place game cards at predetermined positions on the play mat 10, i.e., in areas for the layout game cards, the hand game cards, and the deck game cards, for example. Using the placement frames as a reference, the player places game cards at predetermined positions on the play mat 10. The processor 21 detects game cards on the play mat 10 through the same processing as the detection processing described later, based on the camera image data 304, and determines whether or not placement of game cards at predetermined positions is finished. If placement of game cards at predetermined positions is finished, the processor 21 projects a predetermined game start message, for example, to let players start game play.

### Acquisition of Camera Image

Next, in step S2, the processor 21 acquires the camera image data 304 sent from the camera 27.

### Identification of Play Mat Area

Next, in step S3, the processor 21 cuts out a part corresponding to the play mat 10 from the camera image, to generate the detection processing image data 305. Specifically, the following processing is performed. First, the processor 21 identifies a part (hereinafter, play mat area) corresponding to the play mat 10 in the camera image, using the play mat definition data 303. In the exemplary embodiment, the play mat area in the camera image is identified using, as markers, the “lists of combinations” printed at two locations described above. That is, the processor 21 performs predetermined image recognition processing for the camera image data 304, and detects the “lists of combinations” at two locations, thus identifying the positions thereof. The mutual positional relationship of the “lists of combinations” on the play mat 10 is defined in the play mat definition data 303. Therefore, if the positions of the two lists of combinations are known, the position of the play mat area in the camera image can be identified. Further, the processor 21 generates an image (hereinafter, a detection processing image; see FIG. 15) in which areas corresponding to parts where the “lists of combinations” are printed are masked with black, in the identified play mat area, and stores the image as the detection processing image data 305.

As described above, identifying the play mat area from the camera image and preparing an image in which the lists of combinations are masked with black, provides the following advantage.
The position of the play mat 10 in the camera image is identified based on the lists of combinations, and the projection position of an image to be projected can be determined based on the identified position. Thus, even if the position of the play mat 10 changes during game play, it is possible to project a guide image so as to follow the change.
An item appearing outside the play mat area can be prevented from being erroneously detected as hanafuda.
In the detection processing described later, the size of the image data can be reduced and time required for the detection processing can be shortened, as compared to a case of using a camera image directly as a processing target.
By using the image in which the “list of combinations” parts are masked with black, the “list of combinations” parts where the designs of hanafuda are printed can be prevented from being erroneously detected as hanafuda.
Since the ratio of the physical size of a hanafuda game card to the play mat 10 is known, this ratio can be used in the stabilization processing described later.

### Detection of Hanafuda (Game Item)

Next, in step S4, the processor 21 detects each game card in the camera image, using an object detection AI. That is, detection processing for game cards present on the play mat 10 is performed. Specifically, the processor 21 inputs the detection processing image data 305 to the object detection model 302. As a result, image recognition processing is performed and a BBox described above is outputted as a detection result. That is, position information for each game card and kind information for each game card in the camera image are obtained. The position information may be represented by coordinates in a camera image, or may be information indicating a position in the real world. In the exemplary embodiment, it is assumed that the kind information for each game card is information uniquely identifying the game card. However, in another exemplary embodiment, in accordance with the game content, the category information may be such an element for identifying a “month” in hanafuda or a “suit” in playing cards, for example.

### Stabilization Processing

Next, in step S5, the processor 21 performs stabilization processing for stabilizing the detection result obtained in step S4. This processing is performed in consideration of a possibility that the detection result might not be stabilized when a plurality of frames are observed, depending on the placement position of hanafuda, the positional relationship between the camera 27 and the player, change in the illumination environment, or the like. For example, it is conceivable that a hanafuda game card is not detected even though the hanafuda game card is present or a hanafuda game card is detected to be present even though the hanafuda game card is not present, or it is conceivable that a hanafuda game card is detected as a different kind of hanafuda. Therefore, in order to stabilize the above detection result, the stabilization processing using detection results for a plurality of frames is performed. Through this processing, for example, an inappropriate BBox is deleted, overlapping BBoxes are merged to be one BBox, or a game card that has not been detected temporarily is treated as still being present. Then, an object described above is generated based on the detection result (BBox) in which a result of the stabilization processing is reflected, and the object is stored as the object data 307. By using an object that has undergone the stabilization processing, determination accuracy in the game processing and the like are improved, whereby the game processing can be performed more appropriately. As the stabilization processing, for example, the following processing is performed.

### Examples of Stabilization Processing

### Processing of Deleting Inappropriate BBox

The physical size of the play mat and the physical size of a hanafuda game card are known. Accordingly, among the BBoxes in the detection result, the one that is extremely large or extremely small as compared to the above known size is deleted.

### Processing of Deleting BBox Near Boundary of Play Mat

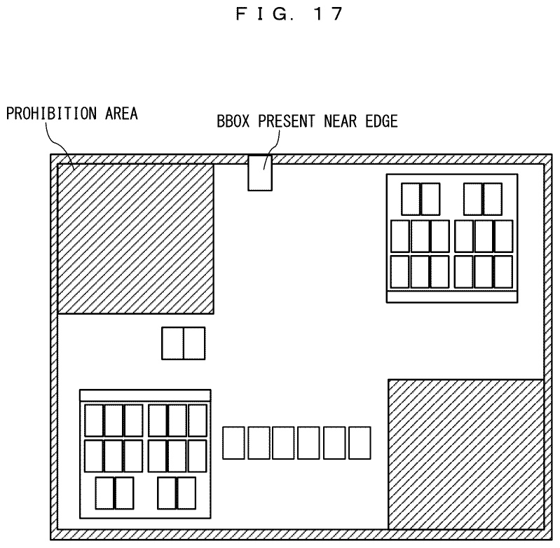

For example, a game card placed near an end of the play mat is often hidden partially, and thus it is considered that the game card might not be distinguished from other hanafuda game cards and such a game card is highly likely to be erroneously recognized. Therefore, for example, a “prohibition area” as shown in FIG. 17 is defined on the play mat. Then, the BBox overlapping the prohibition area is deleted at this stage.

### Merging Processing for Nearby BBoxes in the Same Frame

A case where a plurality of BBoxes are detected for the same hanafuda game card in a detection result for a certain frame, can occur. In such a case, these BBoxes are treated together. For example, a pair of BBoxes for which IoU (Intersection over Union) is equal to or greater than a certain value are merged to be treated as a single object (hereinafter, referred to as a merged object). Here, regarding the merged object, information about the plurality of game cards before merging is kept. At this time, the merged object is treated as an object that might be a game card A or might be a game card B, for example.

### Merging Processing for Objects Close to Each Other When Plural Frames are Observed

In the detection processing, even if an actual game card is still present, a case where a BBox corresponding to the game card is not detected in a certain frame can occur due to various factors such as entry of an obstacle between the camera and the game card. Accordingly, in the exemplary embodiment, a parameter called a “detection parameter” is introduced for the object, to increase robustness against such a phenomenon that a BBox corresponding to the object is not detected temporarily. Specifically, in this processing, for example, an object that had been obtained as a detection result until the last frame is compared with an object newly obtained in the present frame, and the objects for which IoU is equal to or greater than a certain value are merged. Further, a parameter called a detection parameter is set for the objects as described above. Then, the detection parameter for the object (game card) detected in the present frame is increased, and the detection parameter for the other object is decreased. Thus, even in a case where a certain game card is not detected temporarily, if the detection parameter for the object corresponding to the game card is equal to or greater than a certain value, the game card can be treated as still being present at the position where the game card had been present until the last frame, although the game card is not detected in the present frame. Regarding the merged object, the detection parameter is imparted for each of game cards that might be included in the merged object. Then, the merged object can be identified as one of the game cards through the following processing.

### Adjustment Processing for Hanafuda Game Cards That are Likely to be Erroneously Recognized

In a case where the kinds of game cards that are likely to be erroneously recognized are known as preliminary information, the following processing is performed for such game cards. For example, it is assumed that one game card A and one game card B are placed in the layout game card area. In this case, ideally, the game card A should be detected as “game card A”, and the game card B should be detected as “game card B”. However, a case where both game cards are detected as “game card A” can occur for some reason. In this case, the game card detected as “game card A” is the game card A with a probability of X %, and is the game card B with a probability of Y % (=100%−X %). In the exemplary embodiment, in such a case, the detection parameter for the game card detected as “game card A” is distributed as a detection parameter X % for the game card A and a detection parameter Y % for the game card B. Thus, accuracy of the “hanafuda kind assignment processing” can be improved. In addition, the above two game cards each have detection parameters as “game card A” and “game card B”. Thus, through the “hanafuda kind assignment processing” described below, if one of the game cards is assigned as “game card A”, the other one is assigned as “game card B” without being deleted because of absence of an assignment destination.

In another exemplary embodiment, without performing distribution of detection parameters, when a kind of hanafuda is to be assigned to a certain game card through “hanafuda kind assignment processing” described below, if the kind has already been assigned to another game card, the certain game card may be assigned as a prescribed kind of game card.

### Hanafuda Kind Assignment Processing

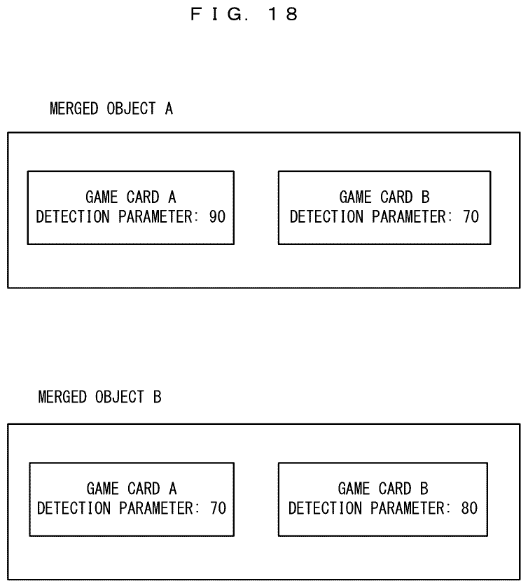

In the stabilization processing, processing of assigning a kind of hanafuda to each object is performed. The maximum number of game cards for each kind of hanafuda that can exist is known. Using this fact, a kind of hanafuda is assigned to each object. It suffices that the kind of hanafuda indicated by a BBox is assigned to a game card, as long as there are no other objects (BBoxes) detected as the same game card as that game card. On the other hand, regarding game cards that are likely to be erroneously recognized as described above, if a plurality of game cards are detected as the same kind of game card, the following processing is performed. For example, it is assumed that the maximum number of game cards for each kind is 1 and two game cards, i.e., a “game card A” and a “game card B”, are detected as the same kind of game card, i.e., “game card A”. In this case, matching is sequentially performed in an order from a merged object having the highest detection parameter for the game card A. For example, it is assumed that there are two merged objects each including “game card A” and “game card B” which are likely to be erroneously recognized. One of these merged objects is defined as an object A, and the other one is defined as an object B. Then, it is assumed that detection parameters are distributed as shown in FIG. 18, for example, through the above “adjustment processing for hanafuda game cards that are likely to be erroneously recognized”. In this case, a kind “game card A” is assigned to the object A having a higher detection parameter for hanafuda A. On the other hand, another kind “game card B” is assigned to the object B because a kind “game card A” has been already assigned.

### Deletion Processing

Further, in the stabilization processing, processing of deleting an object for which the detection parameter has become 0 is performed. That is, processing of deleting an object that is not used is performed.

After the detection result by the object detection AI is stabilized through various processes as described above, the game processing as described below is performed.

### Hanafuda Game Processing

Returning to FIG. 16, next, in step S6, the processor 21 executes various kinds of game processing according to the rule of hanafuda, based on the detection result that has gone through the stabilization processing. Then, based on the result, the content of an image to be projected as the guide image is determined. As long as the guide image as described above can be generated, the specific processing content of the game processing is not limited. For example, the following processing can be performed.
(1) Situation Recognition Processing

First, the processor 21 identifies an object present in each area in the camera image, based on the detection result that has undergone the stabilization processing, and reflects the placement state of the game cards in the game status management data 308. That is, processing of recognizing the placement state of the game cards on the play mat 10 based on the camera image is performed. Specifically, the processor 21 generates an object based on the detection result (BBox). Then, the processor 21 determines which object is placed in each area, based on position information for each object and the range of each area defined in the play mat definition data 303. In other words, processing of separating the camera image into the respective areas described above and determining in which area the object corresponding to each game card is included, is performed. Further, the processor 21 performs, for example, comparison between the placement state at present and the placement state in the last frame derived from the placement state history data 333, to determine whether or not a predetermined game card is newly placed in each area and whether or not any game card has moved between areas. For example, at a timing when it is detected that a predetermined game card is placed in a taken game card area, the processor 21 determines whether or not the object corresponding to the game card is the same as the object corresponding to the game card placed in the hand game card area or the layout game card area in the last frame. Then, based on the result, it can be detected that the game card has moved from the hand game card area or the layout game card area to the taken game card area. In addition, for example, in a case where the detection result indicates that identical game cards are present in the layout game card area and the taken game card area in the processing for the same frame, control is performed so as to prioritize the game card in the taken game card area. That is, control is performed so as to treat the game card as having moved to the taken game card area. Such a determination may be performed at a timing when a game card is placed in the taken game card area. Alternatively, a fact that a predetermined game card moves away from the hand game card area or the layout game card area may be detected, and at this timing, it may be determined that movement to the taken game card area has occurred. Then, based on a result of situation recognition as described above, the processor 21 updates the contents of the 1P hand game card data 322, the 2P hand game card data 323, the 1P taken game card data 324, the 2P taken game card data 325, the layout game data 326, and the deck data 327 in the game status management data 308, as appropriate.
(2) First Combination Condition Determination Processing

Further, for each of the 1P and the 2P, the processor 21 determines whether or not the first combination condition is satisfied between any hand game card and any layout game card at present. A determination method for performing a determination for the first combination condition and the second combination condition described below may be any method. In the exemplary embodiment, the determination processing for combination is performed based on the combination definition data 321 and game cards of the detected hand game cards and layout game cards.
(3) Second Combination Condition Determination Processing

The processor 21 also determines whether or not the second combination condition is satisfied for game cards in the taken game card area. For example, at a timing when a predetermined game card is placed in the taken game card area, whether or not the game card is a game card constituting a predetermined combination is determined. Further, if the game cards is a game card constituting a predetermined combination, processing of specifying the printing position of the design of the corresponding game card on the list of combinations based on the play mat definition data 303 is performed.
(4) Processing Relevant to Taken Game Card A

The processor 21 performs various game processes according to the rule of hanafuda and the game situation, e.g., score calculation based on game cards in the taken game card area. For example, at a timing when it is detected that a predetermined game card is placed in the taken game card area, processing of adding points prescribed for the game card is performed. In addition, whether or not a predetermined combination is completed with the game card is determined, and if the predetermined combination is completed, points associated with the combination are also added.
(5) Other Game Processes

In accordance with the game situation, various processes relevant to the hanafuda game are also performed. In the exemplary embodiment, the case where the first guide image is projected at all times is described as an example. However, in another exemplary embodiment, the content of projection may be changed in accordance with turns of players, and in this case, the following processing may be performed. For example, at the start of the game, control is performed in the first projection mode as described above. That is, a guide image including the first guide image for the 1P but not including the first guide image for the 2P is projected. Thereafter, when it is detected that a predetermined game card is placed in the 1P taken game card area, the mode may be switched to the second projection mode. That is, a guide image not including the first guide image for the 1P but including the first guide image for the 2P may be projected. Thereafter, when it is detected that a predetermined game card is placed in the 2P taken game card area, control may be performed to switch the mode to the first projection mode. Also for the second guide image and the third guide image, in the exemplary embodiment, the case where these images are projected at all times is described as an example, but whether or not to project these images may be controlled in accordance with turns of players and the situation of the game.

Next, in step S7, the processor 21 determines characters and an image that the PJ 28 is caused to project, based on a result of game processing such as combination determination for game cards and position information about objects. Further, based on the determined content, the processor 21 generates the first guide image data 330, the second guide image data 331, and the third guide image data 332. Regarding each guide image data, in each frame, processing of newly generating the image from the beginning based on position information for each object may be performed, or processing of reading and applying image data prepared in advance may be performed. Further, based on position information for each object, the processor 21 determines the position of each guide image in the projection image.

### Output of Image Data to be Projected

Next, in step S8, the processor 21 generates the PJ output image data 309 including the first to third guide images. Then, the processor 21 outputs the PJ output image data 309 to the PJ 28. Thus, a guide image including the first to third guide images is projected from the PJ 28.

### End Determination

Next, in step S9, the processor 21 determines whether or not a predetermined condition for ending the game is satisfied. This condition may be any condition. For example, it may be determined that the game ends, in a case where no hanafuda game cards are detected from the areas any longer, a case where there are no layout game cards remaining, a case where there are no deck game cards remaining, a case where there are no hand game cards remaining, a case where a predetermined number of turns are finished, a case where taken game cards exhibit a predetermined “combination”, a case where a design indicating end is recognized, or a case where a specific operation is performed. If the condition for ending the game is not satisfied (NO in step S9), the process returns to step S2, so that the process is repeated. If the condition for ending the game is satisfied (YES in step S9), the processor 21 ends the game progress assistance process.

As described above, in the exemplary embodiment, when players play a hanafuda game using hanafuda game cards which are actual game items, the placement state of game cards on the play mat is recognized using the object detection AI, and a guide image for providing guide for the way of combining game cards, a candidate of such a combination, and the like is projected on the play mat by the PJ 28. Thus, even a beginner who does not know the rule of the hanafuda game can proceed with the game smoothly. That is, a guide image according to the situation on the play mat can be projected, whereby game progress assistance can be performed more appropriately.

Not only a beginner but also an intermediate player and an advanced player can be assisted in game progress. The processing as described above can be applied to not only hanafuda but also a card game such as a trading card game, for example. In this case, for example, when a combination condition in a game is updated due to addition of a new card to a card pool, an intermediate player and an advanced player can easily understand and recognize the combination condition. Thus, the intermediate player and the advanced player can be assisted in proceeding with the game.

### Modifications

In the above exemplary embodiment, the example in which a hanafuda game is played using hanafuda game cards as game items has been shown. However, as game items, playing cards or the aforementioned trading cards may be employed, for example. Without limitation to card-type items such as hanafuda, game items having a predetermined shape such as a chess piece may be employed, for example. That is, game items are not limited to card-type items as long as the game items are used in a game played with the game items placed on a predetermined field. As a game in which such game items are used, for example, a game in which cards and pieces are arranged in a mixed manner is also applicable. The sizes or the shapes of cards or pieces may not necessarily be the same. For example, game items to be used may be different between players.

In the above exemplary embodiment, the example in which progress assistance processing using projection of a guide image described above is applied to a hanafuda game in which two players compete has been shown. In another exemplary embodiment, the above processing may be applied to a card game or the like played by one person. The above processing may be applied to a game played by two players cooperatively. The above processing may be applied to a game played by three or more players competitively or cooperatively. In a case of a game played by three or more players, the game may be played while the players are divided into two or more teams. In this case, players belonging to the same team may share game cards and areas.

In the above exemplary embodiment, the example in which the play mat 10 has a predetermined design printed thereon has been shown. In another exemplary embodiment, for example, a liquid crystal monitor may be used instead of the play mat 10. That is, the above processing is applicable also to a game played with predetermined game items placed on a liquid crystal monitor on which a predetermined design is displayed. In this case, instead of projecting a guide image from the PJ 28, control may be performed so that an image corresponding to the above guide image is displayed on the liquid crystal monitor. In addition, a desk or a floor on which a predetermined design is drawn is also applicable. Projection may be performed on a desk or a floor by projectors based on different controls. The design may not necessarily be printed as long as the design is imparted. For example, the design may be provided by hand writing or engraving. The play mat may be attached on a wall using a magnet, paste, or the like.

In the above exemplary embodiment, the game processing is performed with the play mat 10 classified into a plurality of areas such as the hand game card areas, the layout game card area, and the taken game card areas. Such area arrangement may be configured as appropriate in accordance with the game content. For example, two areas defined at separate positions that are not adjacent to each other may be grouped and treated as one area in game processing. For example, different areas may partially overlap each other. For example, the layout game card area and the hand game card area may partially overlap each other. In this case, in order to distinguish whether a game card placed at the overlapping part is a hand game card or a layout game card, an object described above may be imparted with information for identifying an area to which the object belongs. In this case, in order to help a player to distinguish between a hand game card and a layout game card, such a frame line image that surrounds the game card by using a color, a shape, or a thickness that differs depending on the area to which the game card belongs may be projected on the hand game card area and the layout game card area.

Irrespective of whether or not the areas overlap each other, information for identifying an area to which the object corresponding to each game card belongs may be imparted to the object. Further, in this case, it may be determined that an operation of moving a game card between areas is performed, when it is determined that a predetermined operation for changing the above information is performed. For example, it is assumed that a liquid crystal monitor is used as the play mat 10. In this case, by a player performing a predetermined operation, information for identifying an area to which a corresponding game card belongs may be rewritten for the corresponding game card. At this time, the game card may not be physically moved in actuality, but the display content on the liquid crystal monitor may be changed through scrolling of the display content, or the like, so as to indicate that the game card has moved from the layout game card area to the taken game card area.

Objects may be classified based on a flag, or a certain bit field in which certain values are assigned to certain areas.

In another exemplary embodiment, the above processing may be applied to a game in which some of the above areas are absent, depending on the game content. For example, the above processing may be applied to a game in which an area corresponding to the taken game card area is not used. In this case, processing may be performed so as to project only the first guide image. The above processing may be applied to a game that includes another area in addition to the areas explained above. The number of areas for each kind of area are not bound to what has been explained above, and may differ depending on the game content.

In the above exemplary embodiment, as a specific example of the printed design of the list of combinations, a design in which the designs (individual combination designs) of game cards of respective combinations are arrayed has been shown. As long as the player can obtain information concerning the combinations, the displaying format is not limited to designs; in this regard, in another exemplary embodiment, for example, a design in which the configuration of each combination can be represented by a character string used as the list of combinations. As another example, a predetermined barcode may be printed instead of the list of combinations. Then, for example, by reading the barcode by a smartphone, a player may display an image corresponding to the list of combinations on the screen of the smartphone.

In the above exemplary embodiment, regarding a method for recognizing the position of the play mat 10 in a camera image, the example in which the position of the play mat 10 in a camera image is identified using the lists of combinations as markers has been shown. That is, the example in which a part of the play mat 10 is used as a marker has been shown. Then, the example in which the position of the play mat 10 in the camera image is identified based on the position of the marker, and, for example, size information and position information defined in the play mat definition data 303 in advance, has been shown. In this regard, in another exemplary embodiment, the position of the play mat may be recognized using the entirety of the play mat as a marker. In this case, the position of the play mat in the camera image may be identified directly from the recognized position of the play mat.

Regarding the hand game card area, in another exemplary embodiment, instead of the configuration in which game cards are placed on the play mat 10 as described above, a game in such a style that players hold hand game cards in their hands while playing the game may be employed. In this case, the camera 27, or another camera may be placed in a position where it can capture what the player is holding in their hand. Then, various kinds of processing described above may be performed while the cards which the player is holding in their hand appearing in the camera image is treated as the hand game card area described above.

In the above exemplary embodiment, since hanafuda is used as an example, the first combination condition involves “game cards belonging to the same month”, and the second combination condition involves a “combination”. However, the combination conditions are not limited thereto and may involve any ways of combination defined in advance, depending on the game. For example, a first combination condition may be that “cards have the same design” or that cards have the same color. In the above exemplary embodiment, regarding the number of targets to be combined, the example in which two game cards are combined in the first combination condition has been shown. In another exemplary embodiment, the first combination condition may be that two of hand game cards and one layout game card satisfy a predetermined condition. For example, in a case where a player has a card of kind A and a card of kind B as hand game cards, when the player puts out these two cards, a predetermined game effect, e.g., an attack spell, may be exerted, whereby the player can acquire one card of a predetermined kind present in the field and thus can acquire a total of three cards. Alternatively, in the above case, only one selected card present in the field may be acquired while the two hand game cards remain in the field. Also, for the second combination condition, any condition in which a specific way of combination is defined, without limitation to “combination” as described above, may be adopted. The first combination condition and the second combination condition may be the same combination condition. The combination conditions may be different among players. Each combination condition is not limited to a way of combining cards placed in specific areas, e.g., a hand game card or a layout game card, and depending on the game, any areas may be defined in advance as areas where cards to be combined are placed. For example, a condition regarding a way of combination in the same area may be adopted, or a condition regarding a way of combining cards placed in a plurality of areas may be adopted.

In another exemplary embodiment, in addition to the guide images as described above, frame line images as described above may be projected on game cards placed on the play mat 10. Thus, the position of each game card on the play mat 10 can be more easily recognized.

Regarding the camera 27, a normal digital camera may be used, or for example, an infrared camera may be used, depending on the game content. Regarding the imaging range of the camera 27 and the placement position of the camera 27, for example, the imaging range may be equal to the size of the play mat, the imaging range may be larger than the size of the play mat 10, or the imaging range may be smaller than the size of the play mat 10. The camera 27 may be placed at any position while satisfying any of the above conditions.

In the above exemplary embodiment, as a method for identifying information about each game card in the camera image, a method using the item detection AI has been shown. That is, a method in which an identified content is checked against a database and the kind of the game card is identified, has been shown. In another exemplary embodiment, a character or a code for identification may be provided by printing or the like on a game item such as a card. Then, by recognizing such information, the kind of the game item may be directly identified, without checking against a database.

The projection range of the PJ 28 may have the same size as the play mat 10, as with the camera 27, or may have a larger size or a smaller size than the play mat. As long as such a condition is satisfied, the placement position of the PJ 28 may be any position.

In the above exemplary embodiment, the case where the above processing is executed by a single PC 2 has been shown. The PC 2 may include a plurality of storages and processors. Then, the above processing may be executed while being shared among the storages and the processors. The above processing may be executed in a distributed system composed of a plurality of information processing apparatuses including a server.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. A game progress assistance system for providing assistance in a game that progresses using game items placed in a field, the game progress assistance system comprising:
a camera configured to capture an image of the field;
a projector configured to project a projection image on the field; and
one or more processors configured to
acquire object information including at least position information and category
information of an object based on an image of an object corresponding to the game item, included in the captured image,
based on the object information, perform a first combination determination to determine a combination that satisfies a predetermined first combination condition among combinations of any of first objects located in a first area in the captured image and any of second objects located in a second area in the captured image, and
generate the projection image including a first combination indication indicating the combination that satisfies the first combination condition.

2. The game progress assistance system according to claim 1, the one or more processors further configured to
based on the position information, detect that each of the objects included in the determined combination of the first object and the second object which satisfies the first combination condition is moved to a third area in the captured image, and
generate a projection image including a third area indication regarding the third area, when it is detected that the object is moved to the third area.

3. The game progress assistance system according to claim 1, wherein
the game is a game in which a plurality of players compete,
the first area is associated with a first player,
in the first combination determination, based on the object information, the combination that satisfies the first combination condition among combinations of any of fourth objects located in a fourth area in the captured image which is an area associated with a second player, and any of the second objects located in the second area, is determined, and
in the generation of the projection image, the projection image including the following first combination indications is generated:
the first combination indication indicating the combination that satisfies the first combination condition among combinations of any of the first objects located in the first area and any of the second objects located in the second area; and
the first combination indication indicating the combination that satisfies the first combination condition among combinations of any of the fourth objects located in the fourth area and any of the second objects located in the second area.

4. The game progress assistance system according to claim 2, wherein
the first area and the third area are associated with a first player,
in the first combination determination, based on the object information, the combination that satisfies the first combination condition among combinations of any of fourth objects located in a fourth area in the captured image which is an area associated with a second player, and any of the second objects located in the second area, is determined,
in the detection, based on the position information, it is detected that each of the objects included in the determined combination of the second object and the fourth object which satisfies the first combination condition is moved to a fifth area in the captured image which is an area associated with the second player, and
in the generation of the projection image, the projection image including a fifth area indication regarding the fifth area is generated, when it is detected that the game item is moved to the fifth area.

5. The game progress assistance system according to claim 4, wherein
the game is a game in which a plurality of players compete while taking turns,
a generation mode is switchable between
a first generation mode in which the projection image is generated so as to include, in the projection image, a 1P-side combination indication which is the first combination indication indicating the combination that satisfies the first combination condition among combinations of the first objects and the second objects, and so as not to include, in the projection image, a 2P-side combination indication which is the first combination indication indicating the combination that satisfies the first combination condition among combinations of the fourth objects and the second objects, and
a second generation mode in which the projection image is generated so as not to include the 1P-side combination indication in the projection image and so as to include the 2P-side combination indication in the projection image,
when movement of the object from the second area to the third area is detected, the generation mode is switched from the first generation mode to the second generation mode, and
when movement of the object from the second area to the fifth area is detected, the generation mode is switched from the second generation mode to the first generation mode.

6. The game progress assistance system according to claim 2, wherein
the captured image includes a second combination condition indication area including an indication of a second combination condition regarding a plurality of kinds of combinations of the objects, and
a projection image including a second combination indication in which each of third objects which are the objects located in the third area and an indication of the second combination condition associated with the third object among a plurality of indications of the second combination conditions included in the second combination condition indication area, are associated with each other, is generated.

7. The game progress assistance system according to claim 6, the one or more processors further configured to
based on an image of a second condition design indicating the second combination condition and included in a design of the field, acquire position information about the second condition design in the captured image, and
based on the position information about the second condition design, acquire position information about the field in the captured image, wherein
in the generation of the projection image, the projection image is generated based on the position information about the field.

8. The game progress assistance system according to claim 1, wherein
in the generation of the projection image, a placement position of the first combination indication in the projection image is determined based on the position information about each of the objects included in the combination that satisfies the first combination condition, to generate the projection image.

9. The game progress assistance system according to claim 8, wherein
the first combination indication includes a line connecting frame indications corresponding to where the objects that satisfy the first combination condition are located at.

10. The game progress assistance system according to claim 8, wherein
the game items corresponding to the first objects are arranged in a line along one predetermined direction in an area on the field corresponding to the first area,
the game items corresponding to the second objects are arranged in at least two lines along one predetermined direction in an area on the field corresponding to the second area, and
in the generation of the projection image, the first combination indication is generated so as to include frame indications respectively enclosing the objects that satisfy the first combination condition, and a line of which a start point is a predetermined position on an outer edge on the second area side of the frame indication enclosing the first object located in the first area in the combination of the objects that satisfies the first combination condition, and an end point is a position in the frame indication enclosing the second object in the combination of the objects that satisfies the first combination condition.

11. The game progress assistance system according to claim 10, wherein
the frame indication is an indication of a rectangular frame, and
the line is a straight line of which a start point is a predetermined position on a side line on the second area side of the frame indication and an end point is a center position in the frame indication enclosing the second object.

12. The game progress assistance system according to claim 1, wherein
the game items are card-type game items of which designs on at least one side are different from each other, and
in the acquisition of the object information, the category information is acquired based on the designs of the game items.

13. A computer-readable non-transitory storage medium having stored therein a game progress assistance program to be executed by one or more processors of a game progress assistance system for providing assistance in a game that progresses using game items placed in a field, the game progress assistance system including a camera configured to capture an image of the field where the game items are placed, and a projector configured to project a projection image on the field, the game progress assistance program causing the processor to:
acquire object information including at least position information and category information of an object based on an image of an object corresponding to the game item, included in the captured image;
based on the object information, perform a first combination determination to determine a combination that satisfies a predetermined first combination condition among combinations of any of first objects located in a first area in the captured image and any of second objects located in a second area in the captured image; and
generate the projection image including a first combination indication indicating the combination that satisfies the first combination condition.

14. The computer-readable non-transitory storage medium having stored therein the game progress assistance program according to claim 13, the game progress assistance program causing the processor to:
based on the position information, detect that each of the objects included in the determined combination of the first object and the second object which satisfies the first combination condition is moved to a third area in the captured image; and
generate a projection image including a third area indication regarding the third area, when it is detected that the object is moved to the third area.

15. The computer-readable non-transitory storage medium having stored therein the game progress assistance program according to claim 14, wherein
the captured image includes a second combination condition indication area including an indication of a second combination condition regarding a plurality of kinds of combinations of the objects, and
a projection image including a second combination indication in which each of third objects which are the objects located in the third area and an indication of the second combination condition associated with the third object among a plurality of indications of the second combination conditions included in the second combination condition indication area, are associated with each other, is generated.

16. The computer-readable non-transitory storage medium having stored therein the game progress assistance program according to claim 15, the game progress assistance program causing the processor to:
based on an image of a second condition design indicating the second combination condition and included in a design of the field, acquire position information about the second condition design in the captured image; and
based on the position information about the second condition design, acquire position information about the field in the captured image, wherein
in the generation of the projection image, the projection image is generated based on the position information about the field.

17. The computer-readable non-transitory storage medium having stored therein the game progress assistance program according to claim 13, wherein
in the generation of the projection image, a placement position of the first combination indication in the projection image is determined based on the position information about each of the objects included in the combination that satisfies the first combination condition, to generate the projection image.

18. The computer-readable non-transitory storage medium having stored therein the game progress assistance program according to claim 13, wherein
the game items are card-type game items of which designs on at least one side are different from each other, and
in the acquisition of the object information, the category information is acquired based on the designs of the game items.

19. A game progress assistance method to be executed by a computer of a game progress assistance system for providing assistance in a game that progresses using game items placed in a field, the game progress assistance method causing the computer to:
acquire object information including at least position information and category information of an object based on an image of an object corresponding to the game item, included in the captured image captured by a camera configured to image the field;
based on the object information, perform a first combination determination to determine a combination that satisfies a predetermined first combination condition among combinations of any of first objects located in a first area in the captured image and any of second objects located in a second area in the captured image;
generate a projection image including a first combination indication indicating the combination that satisfies the first combination condition; and
output the projection image to a projector configured to project the projection image on the field.

20. An entertainment facility comprising:
a field where game items are placed;
a camera provided at such a position that allows the field to be included in an imaging range;
a projector provided at such a position that allows the projector to project a projection image on the field; and
one or more processors being configured to
acquire object information including at least position information and category information of an object based on an image of an object corresponding to the game item, included in the captured image,
based on the object information, perform a first combination determination to determine a combination that satisfies a predetermined first combination condition among combinations of any of first objects located in a first area in the captured image and any of second objects located in a second area in the captured image, and
generate the projection image including a first combination indication indicating the combination that satisfies the first combination condition.
